(19) United States
(12) Patent Application Publication
(10) Pub. No.: US 2003/0148002 A1
(43) Pub. Date: Aug. 7, 2003

(54) Packaging for bacon and associated packaging method

(76) Inventor: Adele Mercier, Dania, FL (US)

Correspondence Address: GOLD & RIZVI, P.A., Suite 450, 600 North Pine Island Rd., Plantation, FL, 33324, US

(21) Appl. No.: 10/068,544

(22) Filed: Feb. 6, 2002

(51) Int. Cl. A23B 4/00

(52) U.S. Cl. 426/115

(57) ABSTRACT

A packaging for bacon strips or other meats or the like and an associated packaging method in which a strip of bacon is placed along one edge of a length of cellophane or other wrapping material. The wrapping material is wrapped around the bacon strip, and another bacon strip is placed over the first bacon strip. The wrapping material is then wrapped around the second bacon strip, and the process is repeated for the desired number of bacon strips. In another embodiment, a bottom layer of cardboard or other support material is positioned over one end of a piece of cellophane or other covering material. A predetermined number of strips of bacon are placed in parallel on the support material. Another piece of support material is placed over the strips of bacon, etc., until the desired number of layers of bacon strips has been attained. Finally, the covering material is wrapped around all of the layers of bacon.

### BACKGROUND OF THE INVENTION

1. Field of Invention

The instant invention relates to packaging for bacon, and to an associated method for wrapping bacon in the packaging.

2. Description of the Prior Art

U.S. Pat. No. 2,509,450 to Reed et al. discloses bacon packaging in which individual strips of bacon 15 are deposited on a strip 10 of parchment type paper, cellophane or the like with spaces 17 between each strip of bacon 15.

After the strips of bacon 15 are deposited on the strip 10 of paper or cellophane, the strip 10 is then folded so that the strips of bacon 15 are partially overlapped. The strips 10 of paper of cellophane separate each adjacent strip of bacon.

In wrapping the strips of bacon 15, care must be taken so that the strips of bacon 15 and the strip 10 of paper or cellophane are overlapped by the same amount every time. If adjacent strips of bacon are not covered by the paper or cellophane, then the strips will stick together.

U.S. Pat. No. 2,817,198 to Crowley et al. discloses a bacon packaging machine to produce packs of sliced bacon of the type shown in FIGS. 23 and 24 of the patent.

The packaging disclosed by Crowley et al. is identical to that disclosed in the '450 patent described above, except that the folds are reversed. Thus, the packaging suffers from the same drawbacks mentioned above with respect to the '450 patent.

U.S. Pat. No. 2,665,993 to Swanson discloses a bacon package in which the individual strips of bacon are protectively stored between thin separator leaves anchored together along a common side (FIGS. 1-6) or, in an alternative embodiment, to a separate rear sheet 18 (FIGS. 17-20).

Thus, in Swanson, the separator leaves are like “pages” of a “book”, and the strips of bacon are stored between each “page”. This construction, however, is complicated and assembly is relatively time consuming.

### SUMMARY OF THE INVENTION

An object of the present invention is to provide a simple and efficient package for bacon.

A further object of the present invention is to provide a simple and efficient method for packaging bacon.

These and other objects are achieved according to the first embodiment of the invention by providing bacon packaging comprising a single sheet of packaging material (e.g., clear cellophane or the like) which is folded in a predetermined fashion around the strips of bacon so that adjacent strips of bacon are completely separated by the packaging material.

The packaging material can be provided with perforations in predetermined positions so that excess packaging material can be removed (i.e., torn away) as individual strips of bacon are removed from the packaging. The packaging material may also be provided with a tapered end to make it easier to grasp the end of the packaging material and, thus, to unwrap the packaging material.

In a second embodiment of the invention, the strips of bacon extend in parallel and are supported on cardboard or other support material. There can be any number of layers of cardboard and strips of bacon. One end of a cellophane wrapper or other covering material is wrapped around the layers of support material and bacon to protectively surround and enclose the bacon. When the covering material is lifted, the top layer of bacon is exposed. After the top layer has been used, the covering material is wrapped over the next layer of bacon strips to seal the strips again.

The packaging method corresponding to the first embodiment comprises the steps of placing an initial strip of bacon along an edge of a piece of packaging material or a predetermined distance away from the edge, placing the remaining strips of bacon on the packaging material to extend in parallel with the initial strip of bacon, folding the packaging material around the initial strip of bacon, and then folding the packaging material around the remaining strips of bacon until all of the strips are protectively surrounded, in a spiral fashion, by the packaging material.

The packaging method corresponding to the second embodiment comprises the steps of placing a piece of cardboard or other support material over one end of a piece of cellophane or other covering material, placing the bottom layer of bacon strips on top of the support material, placing another piece of support material over the strips of bacon, placing additional layers of bacon strips and support material, and then wrapping the covering material around the top layer of bacon strips, with the opposite edge of the covering material being wrapped around the one end of the covering material under the lowermost support material thereby sealing the bacon strips. To remove the strips of bacon, the covering material is unwrapped and the strips are taken from the exposed support material. The covering material is then wrapped around the remaining layers to again seal the strips of bacon.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a top view showing a packaging for bacon and an associated packaging method (as indicated by the lettered arrows) according to the first embodiment of the invention;

FIG. 1A is a top view showing a modification of the packaging method of the first embodiment;

FIG. 2 is a side cross-sectional view showing the (spirally wrapped) of the first embodiment of the invention;

FIG. 3 is a side cross-sectional view showing a package for bacon according to the second embodiment of the invention;

FIG. 4 is a top perspective view of the bacon package of the second embodiment;

FIG. 5 is a bottom perspective view of the bacon package of the second embodiment;

FIG. 6 is a side cross-sectional view showing a package combining the first and second embodiments of the invention; and

FIG. 7 is a top perspective view showing a different package combining the first and second embodiments of the invention.

### DETAILED DESCRIPTION OF PREFERRED EMBODIMENTS

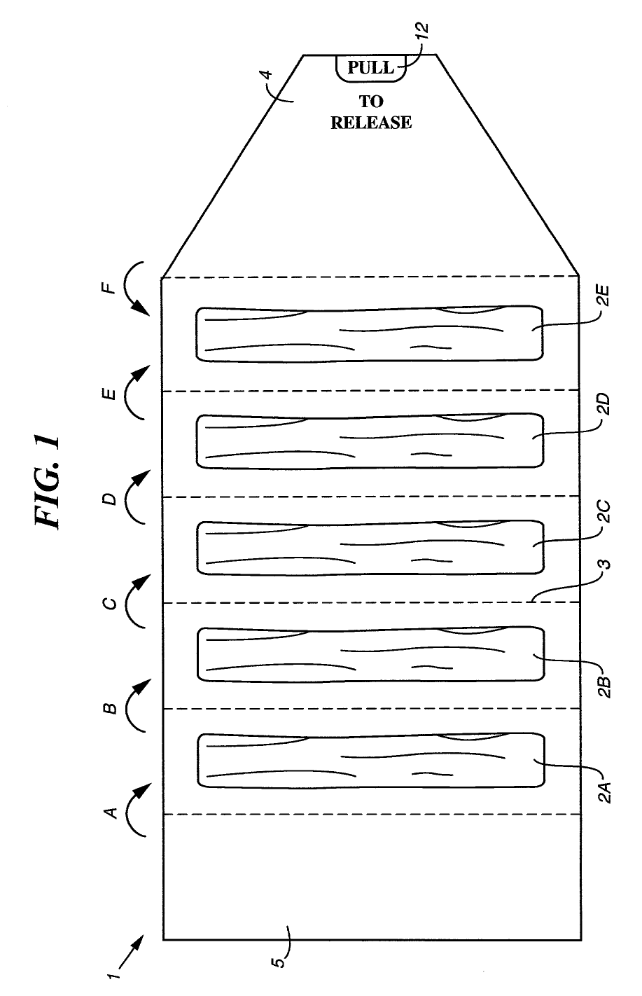

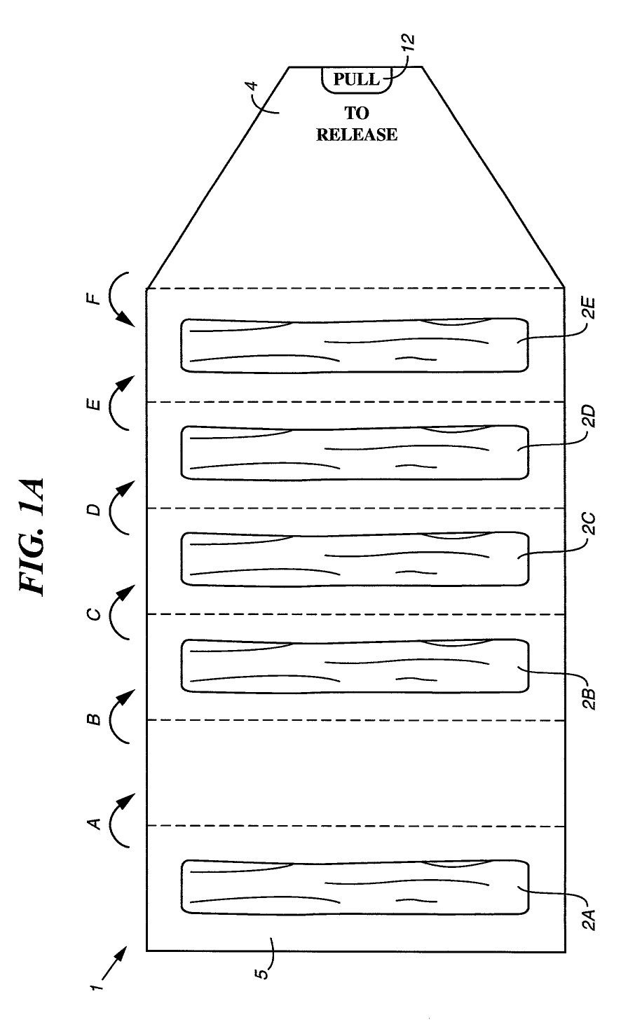

Referring now to the drawings, FIG. 1 shows the first embodiment of the invention. Individual strips of bacon 2A-2E are placed on cellophane or other wrapping material 1 as shown in FIG. 1. The wrapping material 1 is generally rectangular and of sufficient size to accommodate the desired number of strips of bacon. Further, the wrapping material must be able to withstand freezing temperatures without crumbling. An overlapping edge 5 is employed to provide a flap for covering bacon strip 2A, the material 1 being folded in the direction shown by arrow A in FIG. 1. In a slight modification of the first embodiment (see FIG. 1A), the bacon strip 2A can be placed on top of the overlapping edge 5, in which case the position between bacon strips 2A and 2B is empty. In this alternative placement (see FIG. 1A), the bacon strip 2A and the edge of flap 5 are folded over together in the direction shown by arrow A in FIG. 1A. The strips of bacon 2A-2E can be placed on the wrapping material 1 prior to folding the wrapping material or simultaneously as the wrapping material is folded.

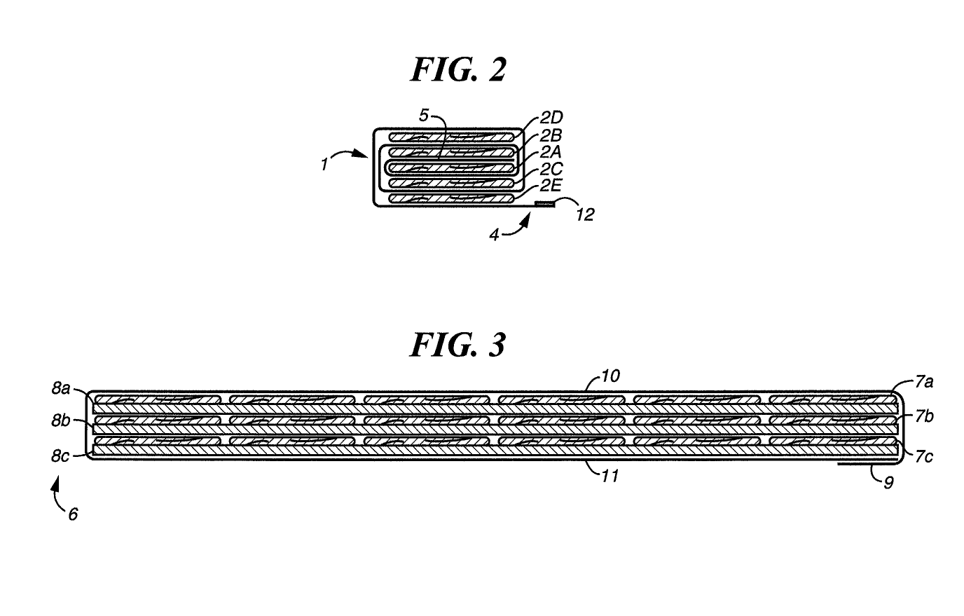

The folding of the bacon strips 2A-2E in the wrapping or covering 1 is continued (as shown by the arrows “A” to “E”) until the bacon strips are spirally enclosed within the covering 1, as shown in FIG. 2. Then, a tapered portion 4 of the covering 1 is wrapped in the opposite direction (“F” in FIGS. 1 and 1A) to seal the strips of bacon within the packaging.

The right hand tapered portion 4 in FIGS. 1, 1A and 2 makes it easier to grasp the end of the covering 1 when it is desired to remove the bacon strips 2A-2E. A piece of tape or other marker 12 may be placed on the end of the taper to indicate that the user should pull the taper to expose the bacon. The perforations 3 make it easier for the user to remove excess covering material 1 as each bacon strip is removed from the packaging.

The packaging and corresponding packaging method of the first embodiment are advantageous to the consumer since the packaging does not require excessive handling of the bacon. The packaging avoids messy situations experienced with conventional bacon packages. Further, the strips of bacon are efficiently and simply removed by unfolding the packaging and tearing off excess wrapping material, if desired.

In addition, the packaging and corresponding packaging method are advantageous to the commercial packager since the do not require complicated folding machinery which would ensure a precise folding width for preventing adjacent strips of bacon from contacting each other and sticking together. Since the bacon strips are folded within the wrapping material in a spiral fashion, there is no possibility that the strips of bacon will stick together. All of the strips of bacon are completely covered by the wrapping material and, therefore, protectively sealed within the package. Thus, there are no exposed portions which would require additional packaging material. Accordingly, the packaging is both simpler and more cost effective than conventional packaging.

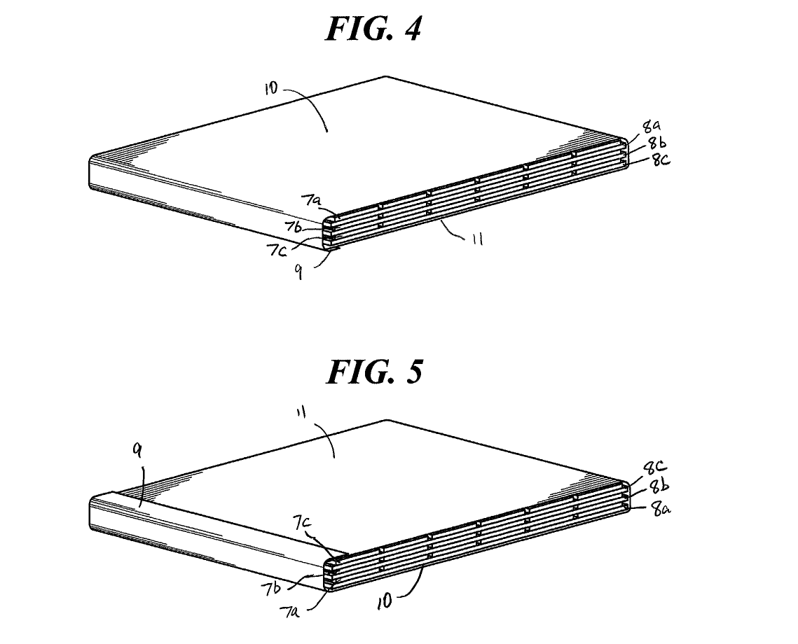

FIGS. 3-5 show a second embodiment of the present invention with three layers of bacon strips 7a, 7b, and 7c. Each layer of bacon is supported by a layer of cardboard 8a, 8b, and 8c or other support material. A protective covering 6 is wrapped around the layers of bacon. The base end 11 of the covering 6 is placed below the lowermost cardboard layer 8c, and the remainder 10 of the covering 6 is wrapped around the layers of bacon as shown in FIG. 3. The end 9 of the covering is wrapped over (i.e., overlaps) the opposite end of the covering beneath the lowermost cardboard layer 8c to seal the strips of bacon in the packaging. FIG. 4 shows a top view of the package according to the second embodiment, and FIG. 5 shows a bottom view of the same.

When covering material 6 is removed, several rows of bacon strips in the top layer are exposed. This type of packaging is particularly advantageous in commercial applications, i.e., where large amounts of bacon are needed at one time.

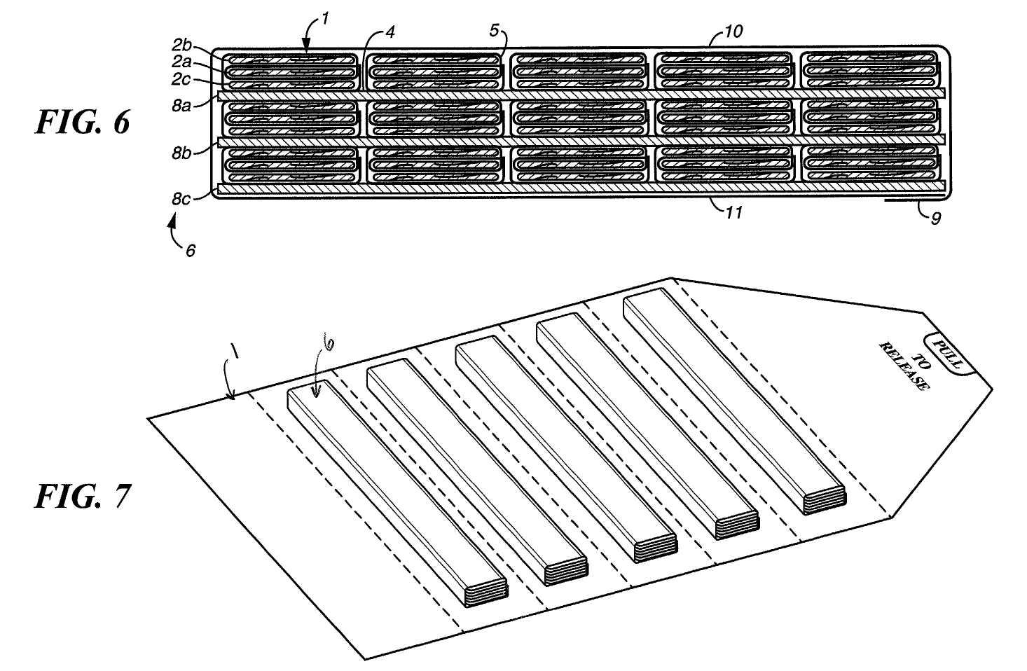

The packaging of the first embodiment could be used in conjunction with the packaging of the second embodiment, as shown in FIG. 6. That is, the spirally-wrapped packages shown in FIG. 2 could replace the individual strips of bacon 7a, 7b and 7c in FIG. 3. The opposite is also true (see FIG. 7). That is, each strip of bacon in accordance with the packaging and method of the first embodiment (FIGS. 1, 1A and 2) could be replaced by a plurality of bacon strips packaged in accordance with the second embodiment (FIGS. 3-5).

The instant invention has been shown and described herein in what are considered to be the most practical and preferred embodiments. It is recognized, however, that departures may be made therefrom within the scope of the invention and that obvious modifications will occur to a person skilled in the art.

What is Claimed is:

1. A bacon package comprising a generally flat, substantially rectangular, packaging material and having a width at least greater that the largest length of each of a plurality of strips of bacon, said packaging material being would spirally to protectively surround the strips of bacon.

2. A bacon package as recited in claim 1, wherein each of the strips of bacon includes opposing major surfaces and opposing edge surfaces, and wherein successive spirals contact an outer one of said opposing major surfaces and both of said opposing edge surfaces.

3. A bacon package as recited in claim 1, wherein said packaging material has a tapered end and perforations.

4. A bacon package as recited in claim 1, wherein said packaging material comprises cellophane.

5. A method for packaging bacon comprising the steps of:
providing a substantially flat and generally rectangular sheet of packaging material;
positioning a first strip of bacon along an edge of the sheet with a gap of predetermined dimension between the strip and the edge of the sheet, wherein the predetermined dimension is at least equal to the width of the first strip of bacon;
folding the edge of the sheet over the strip of bacon;
positioning a second strip of bacon adjacent to the first strip of bacon;
folding the first strip of bacon over the second strip of bacon; and
repeatedly performing the last two steps recited above to protectively package a plurality of strips of bacon in a spiral fashion.

6. A method as recited in claim 5, wherein all of the strips of bacon are positioned on the sheet prior to folding the sheet.

7. A method for packaging bacon comprising the steps of:
providing a substantially flat, generally rectangular, sheet of packaging material;
positioning a first strip of bacon along an edge of one end of the sheet;
folding the first strip of bacon over;
positioning a second strip of bacon adjacent to the first strip of bacon;
folding the first strip of bacon over the second strip of bacon; and
repeatedly performing the last two steps recited above to protectively package a plurality of strips of bacon in a spiral fashion.

8. A method as recited in claim 7, wherein all of the strips of bacon are positioned on the sheet prior to folding the sheet.

9. A bacon package comprising:
at least one support material for supporting a plurality of strips of bacon; and
a protective covering material wrapped around said support material(s) and said strips of bacon.

10. A bacon package as recited in claim 9, wherein said support material comprises plastic.

11. A bacon package as recited in claim 9, wherein said protective covering comprises cellophane.

12. A bacon package as recited in claim 9, wherein an edge of said protective covering is secured to an edge of a bottom one of said support material(s), and wherein an opposite edge of said protective covering overlaps said edge of said protective covering.

13. A method for packaging bacon comprising the steps of:
providing at least one support material, a plurality of bacon strips, and a protective covering;
positioning the support material(s) on top of a portion of the protective covering;
positioning at least one of the bacon strips on top of the support material(s);
positioning another support material(s) over the bacon strips;
repeating the last two recited steps until all of the bacon strips are positioned on top of or between the support material(s); and
wrapping the protective covering around the bacon strips and the support material(s) to form a protective packaging.

14. A method as recited in claim 13, wherein an edge of the protective covering is secured to a bottom on of the support material(s), and wherein an opposite edge of the protective covering overlaps the edge of the protective covering.

15. A bacon package as recited in claim 1, wherein said strips of bacon are supported on a substantially flat and substantially rigid support material.

16. A method for packaging bacon as recited in claim 13, wherein said step of providing a plurality of bacon strips comprises the steps of:
providing a substantially flat and generally rectangular sheet of packaging material;
positioning a first strip of bacon along an edge of the sheet with a gap of predetermined dimension between the strip and the edge of the sheet, wherein the predetermined dimension is at least equal to the width of the first strip of bacon;
folding the edge of the sheet over the strip of bacon;
positioning a second strip of bacon adjacent to the first strip of bacon;
folding the first strip of bacon over the second strip of bacon; and
repeatedly performing the last two steps recited above to protectively package a plurality of strips of bacon in a spiral fashion.

17. A method for packaging bacon as recited in claim 13, wherein the step of providing a plurality of strips of bacon comprises the steps of:
providing a substantially flat, generally rectangular, sheet of packaging material;
positioning a first strip of bacon along an edge of one end of the sheet;
folding the first strip of bacon over;
positioning a second strip of bacon adjacent to the first strip of bacon;
folding the first strip of bacon over the second strip of bacon; and
repeatedly performing the last two steps recited above to protectively package a plurality of strips of bacon in a spiral fashion.
